(19) United States
(12) Patent Application Publication
(10) Pub. No.: US 2024/0359662 A1
(43) Pub. Date: Oct. 31, 2024

(54) VEHICLE WHEEL WELL COMPONENT WITH HEATER

(71) Applicant: FCA US LLC, Auburn Hills, MI (US)

(72) Inventor: Erik DeVito, Royal Oak, MI (US)

(21) Appl. No.: 18/306,319

(22) Filed: Apr. 25, 2023

(51) Int. Cl. B60S 1/68; H05B 1/02; H05B 3/28

(52) U.S. Cl. CPC B60S 1/68; H05B 1/0236; H05B 3/286

(57) ABSTRACT

In at least some implementations, a vehicle wheel well component includes a main body and a heater. The main body is adapted to define at least part of a wheel well of a vehicle, has an outer surface that in an assembled position faces a wheel of the vehicle and defines part of body of the vehicle, and an inner surface spaced from and facing away from the wheel well. The heater is carried by the main body and includes an electrical connector carried by at least one of the main body and the heater and by which electrical power is provided to the heater.

### FIELD

The present disclosure relates to a vehicle having wheels received within wheel wells and including a component that defines at least part of the wheel well and which includes a heater.

### BACKGROUND

During cold weather conditions, snow and ice may accumulate in wheel wells of vehicles. The accumulated snow and ice can form a large cluster or block that extends off the vehicle and which can block or interfere with operation of vehicle components located adjacent to the wheel well, such as a movable/deployable vehicle side step, a camera, a sensor, a light or the like.

### SUMMARY

In at least some implementations, a vehicle wheel well component includes a main body and a heater. The main body is adapted to define at least part of a wheel well of a vehicle, has an outer surface that in an assembled position faces a wheel of the vehicle and defines part of body of the vehicle, and an inner surface spaced from and facing away from the wheel well. The heater is carried by the main body and includes an electrical connector carried by at least one of the main body and the heater and by which electrical power is provided to the heater.

In at least some implementations, the heater includes a base and a heating element carried by the base. The heating element may include a wire or conductive trace that emits heat when electricity is applied to the wire or conductive trace. The heating element may include a conductive material embedded in or coated on the base, and the base may be formed from a polymeric material.

In at least some implementations, the electrical connector is provided in a cavity of the main body and arranged to provide a water-tight connection through which power is supplied to the heater. Suitable pins or other conductors may be provided in the molded-in connector, if desired.

In at least some implementations, the heater includes a temperature sensor that is responsive to the temperature of the heater. In at least some implementations, the heater is arranged at a portion of the main body that defines a lower end of the wheel well and which is adjacent to the lower side of the vehicle. In at least some implementations, the heater provides heat to the main body by conduction.

In at least some implementations, a vehicle includes a wheel well component that defines at least part of a wheel well of a vehicle body, the wheel well is open to an exterior of the vehicle body and extends to and is open to a lower side of the vehicle body. A wheel is located at least partly within the wheel well and has an axis of rotation, the wheel well component is radially spaced from the wheel and the wheel has an axial thickness that is at least partially axially overlapped by the wheel well component. The wheel well component includes a main body having an outer surface that is exposed to the exterior of the vehicle body within the wheel well and an inner surface opposite the outer surface, and the wheel well component also includes a heater carried by the main body and arranged to increase the temperature of the wheel well component when electricity is provided to the heater. In at least some implementations, the heater is arranged against the inner surface of the wheel well component, and is protected from damage by the wheel well component.

In at least some implementations, the heater includes a base and a heating element carried by the base. In at least some implementations, the heating element includes a wire or conductive trace that emits heat when electricity is applied to the wire or conductive trace. In at least some implementations, the heating element includes a carbon-based material that is incorporated into the base which is defined by a polymeric sheet of material. In at least some implementations, the base is formed from polycarbonate.

In at least some implementations, the heater includes a temperature sensor that is responsive to the temperature of the heater, or the vehicle includes a temperature sensor that provides an indication of the ambient temperature outside of the vehicle, or both. In at least some implementations, a control system is provided that is responsive to the output of the temperature sensor and arranged to permit electricity to be provided to the heater when the ambient temperature is below a threshold temperature.

The heater integrated into the wheel well component can prevent snow and ice accumulation on the wheel well component and adjacent components, and can melt snow and ice that have accumulated thereon. The heater may be mounted to an inner surface of the wheel well component, which is a surface that is not exposed to the wheel well and which is protected by a body of the wheel well component from debris and the like that enters the wheel well and which may be displaced by a vehicle wheel.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of a vehicle including multiple wheels and wheel wells;

FIG. 2 is a perspective view of a wheel well component that lines at least part of a wheel well;

FIG. 3 is fragmentary view of part of the vehicle showing part of a wheel well and a camera or sensor located adjacent to an outboard of the wheel well;

FIG. 4 is a fragmentary perspective view of part of the vehicle showing part of the wheel well with the wheel removed and showing an optional side step in an extended position;

FIG. 5 is a plan view of a heater including an electric wire heating element;

FIG. 6 is a plan view of a heater including a polymeric heater film including a heating element incorporated in the film; and

FIG. 7 is a fragmentary cross-sectional view of a main body of a wheel well component that defines part of a wheel well.

### DETAILED DESCRIPTION

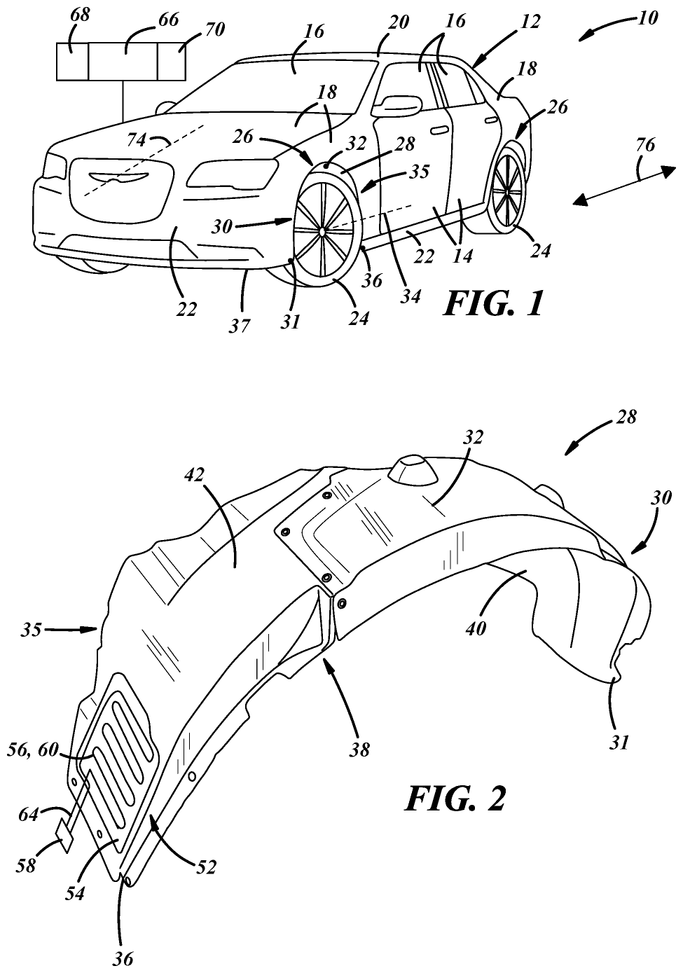

Referring in more detail to the drawings, FIG. 1 illustrates a vehicle 10 having a body 12 defined in part by multiple components mounted to and covering a frame or support assembly. The components include things such as doors 14, windows 16, body panels 18, a roof 20 and exterior trim components 22. And the vehicle 10 includes multiple wheels 24 received at least partly in wheel wells 26.

The wheel wells 26 may include or be defined in part by wheel well components 28 that define part of the vehicle body 12 and that line and define a partly circular cavity that accommodates movement of the wheels 24. The wheel well components 28 may also provide a guard against objects (e.g. rocks or debris) and water displaced (e.g. splashed or thrown) by the wheels 24 and may sometimes be called splash guards. The wheel well components 28 in a wheel well 26 may surround an upper portion of a wheel 24 and may extend circumferentially from a front section 30 spanning from a first end 31 located in front of the wheel 24 (between a front of the vehicle 10 and the wheel 24) and spanning to, toward or beyond a midpoint 32 above a center of the wheel or the axis of rotation 34 of the wheel, and a rear section 35 spanning from the front section 30 to a second end 36 (with the wheel 24 between the front of the vehicle 10 and the rear section 35). The wheel well components 28 may define part of an exterior or outer surface of the vehicle body 12 (e.g. visible from the exterior of the vehicle 10), and the front and rear sections 30, 35 may be adjacent and lead to a lower side 37 of the vehicle body 12 that is adjacent to the ground on which the wheels 24 are received. So arranged, the wheel wells 26 are partially circular cavities that are open outward to a side of the vehicle 10 and downward to or define part of the lower side of the vehicle body 12.

One or more components 28 may define each wheel well 26, and the component or components may be fastened to the vehicle structural assembly or the exterior body components or both. In addition to the circumferential direction, the wheel well components 28 extend axially inwardly from the exterior of the vehicle 10, where circumferential and axial directions are relative to the axis of rotation 34 of the wheel 24 (e.g. when the wheel 24 is oriented at an angle for straight forward or backward vehicle travel). The wheel well components 28 may extend axially any desired extent and may fully or partially axially overlap the wheels 24. As shown in FIG. 2, the wheel well components 28 are typically formed from a molded plastic and have a main body 38 that may be formed from a polymeric or composite material and have an outer surface 40 facing into and exposed to view in the wheel well 26, and facing the wheel 24 therein, and a radially opposite inner surface 42 (FIG. 2) facing away from the wheel well 26 and hidden from view. A thickness of the wheel well components 28 is defined between the outer and inner surfaces 40, 42, and sound or vibration damping material may be provided on the inner surface 40 to reduce noise, if desired.

In cold weather, snow and water may be thrown from the wheels 24 into the wheel well components 28, or otherwise engage the wheel well components 28. Particularly at the rear section 35 of the wheel well 26, snow and ice may stick to and accumulate on the wheel well component 28 (s).

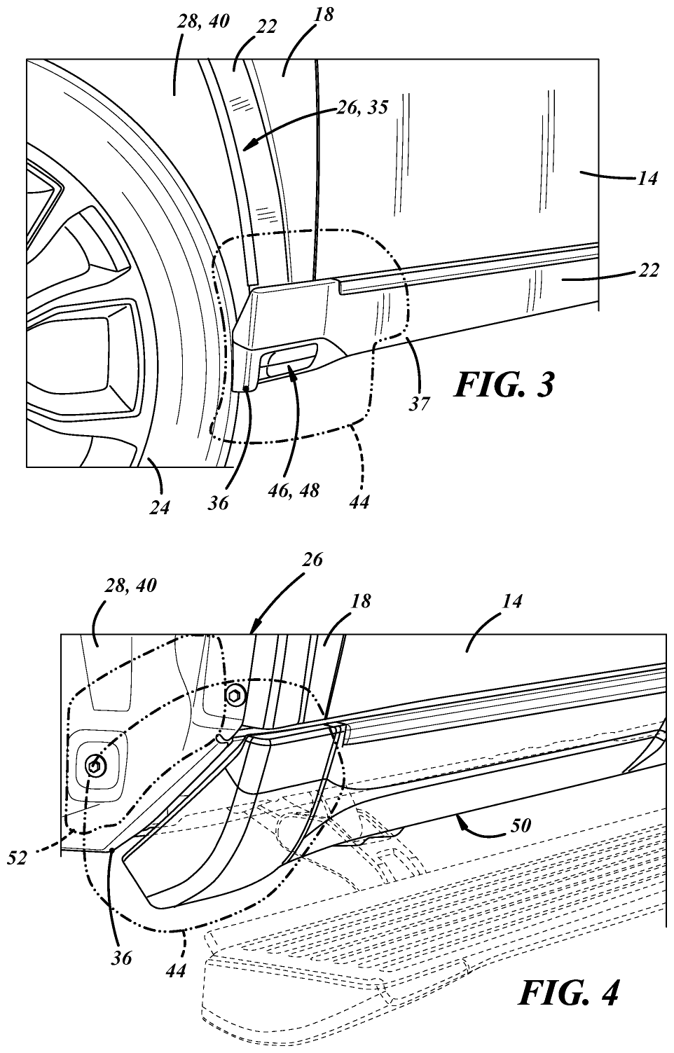

The accumulated snow and ice can cause several problems. For example, the accumulated snow and ice negatively affect vehicle handling and stability, such as by creating an unbalanced condition or impairing free movement of the wheels 24. The accumulated snow and ice can become a road hazard when dislodged from the vehicle 10. The accumulated snow and ice can fully or partially cover a nearby camera or sensor and prevent or impair operation thereof. This is shown in FIG. 3 where accumulated snow/ice is shown by line 44 which covers a sensor 46 or camera 48. The sensor or camera 46, 48 may be associated with an Advanced Driver Assist System (ADAS), and the sensor may be a RADAR or LIDAR sensor by way of two non-limiting examples, and operational impairment can impair or prevent use of the ADAS. Next, the accumulated snow and ice can impair or prevent operation of a movable side step 50. FIG. 4 shows a side step 50 in a retracted position and, in dashed lines, an extended or deployed position. In FIG. 4, accumulated snow and ice is shown by line 44 and such accumulation may affect or prevent deployment of the side step 50 and thereby inhibit or prevent use of the side step. Further, a camera and/or sensor(s) may be incorporated into the side step 50 and in such constructions, failure of the side step 50 to be able to retract fully to its home position may impair or prevent operation of the camera/sensor(s).

As shown in FIGS. 2 and 4, to inhibit or prevent accumulation of snow or ice in or near the wheel well 26, one or more of the wheel well components 28 may include one or more heaters 52. For simplicity of description, a single wheel well component 28 with a single heater 52 will be further described. Because snow and ice most commonly accumulate on or adjacent to the rear section 35 of the wheel well 26, in at least some implementations, the heater 52 is provided on or adjacent to the wheel well component(s) 28 defining the rear section 35 of the wheel well 26. To inhibit or prevent damage to the heater 52 such as by debris that may impact the wheel well component 28, the heater 52 may be provided on or adjacent to the inner surface 42 of the wheel well component 28.

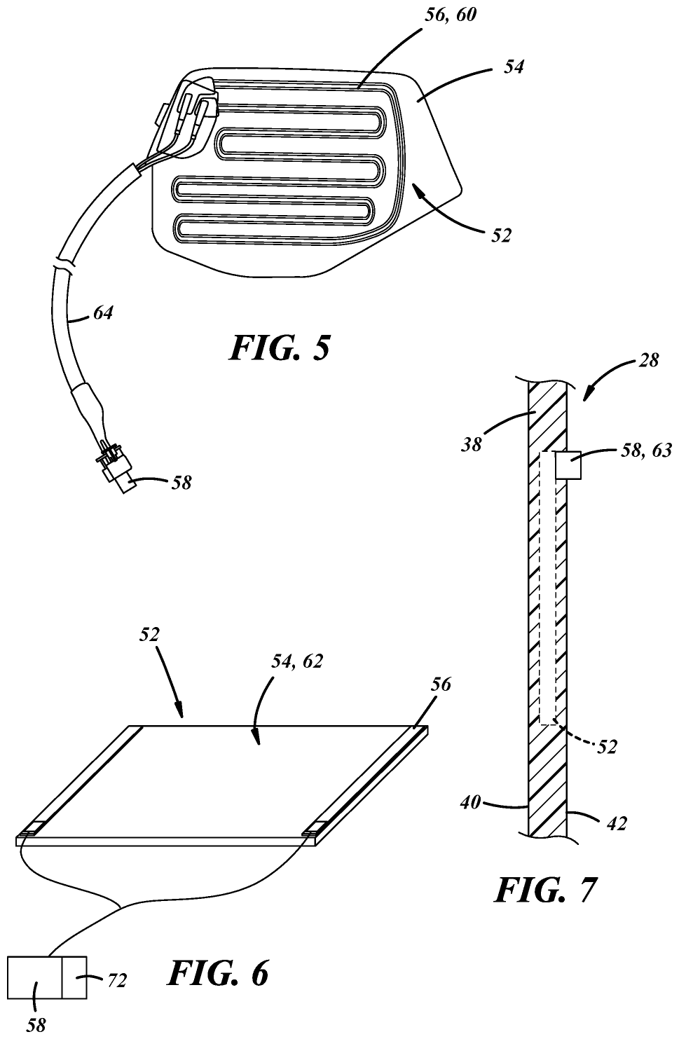

In at least some implementations, the heater 52 is mounted on the inner surface 42 of a wheel well component 28 and includes a base 54 and a heating element 56 carried by the base 54 and an electrical connector 58 through which electricity is provided to power the heater 52. As shown in FIG. 5, the heating element 56 may be an electrically conductive component, like a wire 60 or metallic trace applied to a polymeric base 54, typically in a circuitous path to cover a greater surface area of the base 54 and achieve a desired heating profile across the base 54. As shown in FIG. 6, the heater 52 may include a base 54 which has a conductive element including conductors 56 and a conductive material 62 embedded or coated on the base or otherwise included in the material of the base and electrically coupled to the conductors 56, to enable electrical resistive heating without wires or continuous traces. The conductive material could be a carbon-based material 62 such as, but not limited to, carbon nanotubes (CNT) or nanobuds (CNB) or other carbon forms applied to or incorporated into a base 54 formed from a polymeric sheet or film, defining a conductive film base 54, such as polycarbonate or other polymer CNT films or CNB films. Such conductive films could be transparent, if desired. The film or other base 54 may be flexible and permit the heater 52 to bend and conform to the shape of the wheel well component 28 for improved surface area contact of the heater 52 with the component. In another example, the base is formed from glass and the conductive element is a coating of Indium Tin Oxide (ITO) on the glass, although other heaters may be used.

As shown in FIG. 2, the base 54 may be adhered, fastened or otherwise coupled to the wheel well component 28, such as at or on the inner surface 42, or, as shown in dashed lines in FIG. 7, the heater 52 may be molded onto or overmolded in the wheel well component 28 when that component is formed to provide an integrated component and heater 52. So arranged, in at least some implementations, the heater 52 may be provided on the inner surface 42 or within the wheel well component 28, spaced from the outer surface 40 so it is not directly exposed at the outer surface 40. The electrical connector 58 may be coupled to the base 54 by a cord 64 (FIGS. 2 and 5), or may be directly carried by or coupled to the base 54, such as in a cavity 63 molded or otherwise formed in the wheel well component and exposed to the inner surface 42. The connector 58 may include a watertight or waterproof seal to inhibit or prevent water intrusion into the connector 58.

Electrical power may be provided to the heater 52 by any suitable circuit or power supply of the vehicle 10. In instances where the heater is adjacent to a camera or sensor component, the power may be provided from the camera or sensor component, which may have an output pin via which electrical power can be provided to the heater. When power is provided to the heater 52, the conductive heating element 56 emits heat which is conductively passed into the wheel well component 28, and possibly adjacent vehicle components (e.g. a door 14, body panel 18, trim component 22, sensor 46 or camera 48 side step 50 or the like) and the temperature of the component(s) increase(s). In this way, the heater 52 may be an electric resistance heater 52 where resistance to current flow generates the heat in the heater 52. A suitable fuse, thermistor or the like may be used to prevent overheating and to protect the heater 52, in known manner. Likewise, under or over voltage detection, heat load, short-circuit and other detection/protection may be provided in the circuit or at the heater 52, as desired. The power to the heater 52 may come from the vehicle's electrical system 66 (shown diagrammatically in FIG. 1) and may be, for example, at 12 volts, in range of four to ten amps. In at least some electric vehicle applications (e.g. PHEV/BEV applications) the power supply might be at a higher voltage, like 24-48 volts, and at least some conductive film-based heaters may be better suited for use with the higher voltage power supply.

Power may be selectively provided, for example, only when ambient conditions exist that could enable snow or ice accumulation. In this way, the vehicle 10 may include an ambient temperature sensor 68 (FIG. 1) that provides an output indicative of the temperature outside of the vehicle 10, which may be called the ambient temperature. In such applications, when the ambient temperature is below a threshold, a vehicle control system 70 enables power to be be provided to the heater 52 to increase the temperature of the wheel well component 28 and inhibit snow or ice accumulation on the component. Power may be provided periodically, in any desired interval(s), to reduce energy consumption, if desired.

Rather than or in addition to providing power at intervals/for a period of time, the heater 52 may include or be associated with a local temperature sensor 72 (FIG. 6) that determines the temperature of the heater 52 or adjacent component, and power may be provided to the heater 52 as a function of the output from the local temperature sensor 72 with power provided when the output indicates a temperature below a first threshold and power terminated when the output indicated a temperature above a second threshold which may be above the first threshold. Other factors, like wind chill (cooling effect due to moving air), may be used to determine an effective temperature of the wheel well component 28. Vehicle speed and/or weather data (e.g. from a remote weather information source communicated wirelessly to the vehicle 10) may be used to determine appropriate operation of the heater 52. Vehicle 10 speed may be used in conjunction with a local or ambient temperature sensor to determine an effective temperature based on air temperature and wind/air speed.

The vehicle control system 70 may include a processor with memory including or accessing a program or instructions that operate the heater 52 in a desired manner. The vehicle control system 70 may also operate the ADAS or other sensors 46 and cameras 48. In this way, when operation of a camera 48 or sensor 46 is compromised, which might be determined by a signal provided from the camera or sensor, or determined by the control system 70, the control system 70 may actuate the heater 52 to see if accumulated ice or snow is causing the problem an if so, to reduce or eliminate the accumulation. This system may require that the temperature from a local or ambient temperature sensor 68, 72 be below a threshold before the heater 52 is actuated as the sensor or camera operation may be impaired by matter other than snow or ice, like dirt or debris.

When arranged within a wheel well 26, at least a part and up to all of the heater 52 is oriented perpendicular to a nominal centerline 74 (labeled in FIG. 1) of the vehicle 10 drawn through a center of mass of the vehicle 10 and oriented in a fore-aft direction, represented by arrow 76 and related to straightforward or reverse vehicle travel, or within twenty degrees of perpendicular. Further, at least part of and up to all of the heater 52 is located closer to the nominal centerline 74 than the exterior of the vehicle 10, and relative to the inner surface 42 of a body panel 18 oriented in the fore-aft direction and adjacent to the wheel well 26, where the inner surface 42 of the body panel faces inwardly, toward the nominal centerline.

Via the heater 52, the temperature of a wheel well component 28 can be increased to inhibit or prevent snow or ice accumulation on the component, or to melt and remove an accumulated snow or ice mass from the component. The heater 52 may also increase the temperature of adjacent vehicle components, such as by radiated heat, and inhibit or prevent accumulation of snow or ice on such component(s) or melt accumulated snow and ice from such component(s).

What is claimed is:

1. A vehicle wheel well component, comprising:
a main body adapted to define at least part of a wheel well of a vehicle, the main body having an outer surface that in an assembled position faces a wheel of the vehicle and defines part of body of the vehicle, and an inner surface spaced from and facing away from the wheel well;
a heater carried by the main body; and
an electrical connector carried by at least one of the main body and the heater and by which electrical power is provided to the heater.

2. The component of claim 1 wherein the heater includes a base and a heating element carried by the base.

3. The component of claim 2 wherein the heating element includes a wire or conductive trace that emits heat when electricity is applied to the wire or conductive trace.

4. The component of claim 1 wherein the heating element includes a conductive material embedded in or coated on the base, and the base is formed from a polymeric material.

5. The component of claim 1 wherein the base is formed from a polymeric material.

6. The component of claim 1 wherein the electrical connector is provided in a cavity of the main body and arranged to provide a water-tight connection through which power is supplied to the heater.

7. The component of claim 1 which includes a temperature sensor that is responsive to the temperature of the heater.

8. The component of claim 1 wherein the heater is arranged at a portion of the main body that defines a lower end of the wheel well and which is adjacent to the lower side of the vehicle.

9. The component of claim 1 wherein the heater provides heat to the main body by conduction.

10. A vehicle, comprising:
a wheel well component that defines at least part of a wheel well of a vehicle body, wherein the wheel well is open to an exterior of the vehicle body and which extends to and is open to a lower side of the vehicle body;
a wheel is located at least partly within the wheel well and has an axis of rotation, the wheel well component is radially spaced from the wheel and the wheel has an axial thickness that is at least partially axially overlapped by the wheel well component, wherein the wheel well component includes a main body having an outer surface that is exposed to the exterior of the vehicle body within the wheel well and an inner surface opposite the outer surface, and the wheel well component also includes a heater carried by the main body and arranged to increase the temperature of the wheel well component when electricity is provided to the heater.

11. The vehicle of claim 10 wherein the heater is arranged against the inner surface of the wheel well component.

12. The vehicle of claim 10 wherein the heater includes a base and a heating element carried by the base.

13. The vehicle of claim 12 wherein the heating element includes a wire or conductive trace that emits heat when electricity is applied to the wire or conductive trace.

14. The vehicle of claim 12 wherein the heating element includes a carbon-based material that is incorporated into the base which is defined by polymeric sheet of material.

15. The vehicle of claim 12 wherein the base is formed from a polymeric material.

16. The vehicle of claim 10 wherein the electrical connector is provided in a cavity of the main body and arranged to provide a water-tight connection through which power is supplied to the heater.

17. The vehicle of claim 10 which includes a temperature sensor that is responsive to the temperature of the heater.

18. The vehicle of claim 10 which includes a temperature sensor that provides an indication of the ambient temperature outside of the vehicle.

19. The vehicle of claim 18 which also include a control system that is responsive to the output of the temperature sensor and arranged to permit electricity to be provided to the heater when the ambient temperature is below a threshold temperature.
